(19) United States
(12) Patent Application Publication
(10) Pub. No.: US 2006/0042434 A1
(43) Pub. Date: Mar. 2, 2006

(54) Method and apparatus for slicing a block of material

(76) Inventors: Cole A. Cumpton, Clinton, MO (US); Kenny D. Raymond, Lowry City, MO (US)

Correspondence Address: BRINKS HOFER GILSON & LIONE, P.O. BOX 10395, CHICAGO, IL, 60610, US

(21) Appl. No.: 10/926,369

(22) Filed: Aug. 25, 2004

(51) Int. Cl. B26D 1/03

(52) U.S. Cl. 83/13; 83/932; 83/858; 83/699.61

(57) ABSTRACT

An apparatus for slicing a block of material comprises a harping unit having a blade adaptively attached to a fixed frame, and a feed unit moving the block of material on a feed tray relative to the blade. The blade slices the block of material and leaves uncut a longitudinal tab of material.

The present invention relates, generally, to methods and apparatus for slicing food products and, more particularly, to a method and apparatus for slicing a block of material to facilitate splitting of slices of the block of material.

### BACKGROUND

Conventionally, food product processing lines that slice food items are configured to slice a block or bulk quantity of the food product, and then stack the resulting slices prior to packaging. Cheese is one type of product that such processing lines are often used. As used herein, the term “cheese” is intended to embrace natural cheese, processed cheese, cheese food products, imitation cheese, and the like. Other types of food products may be meat products, such processed meats which typically include Bologna, Salami, and Pastrami, for example.

One such process uses cheese harps. Typically, cheese harps use thin wires stretched across a stainless steel frame. In another arrangement, a cheese log, block, or rectangular section is pushed through a single solid blade to completely severe the cheese block or log into two fully distinct halves or pieces.

For targeted consumptions, at specific food service establishments for example, it is desirable to have the slices of cheese form the cheese log or block pre-cut in half. This cheese pre-cutting step makes it easier and more efficient for a food service employee to use such half slices on a sandwich, for example. Pre-cutting the slices removes the need for the employee to cut the slices in half as this has been done in a more efficient manner at the food processing lines described above.

In the types of cheese processing lines described above, typically the block or log of cheese is first separated in longitudinal halves before slicing. However, the separate longitudinal halves may move relative to one another with later handling causing difficulty in cross-sectional slicing both separate halves simultaneously. Further, the movement of the cheese halves may render subsequent separation of slices difficult.

Thus, in view of the above discussed problems it would desirable to provide an arrangement which facilitates the ability to maintain cheese log or block in its original shape after being sliced longitudinally. This arrangement results in an improved transversal slicing of the cheese block or log at a later stage of the cheese slicing process.

Accordingly, it would be desirable to provide an apparatus and method for slicing cheese blocks or logs which facilitates subsequent separation in sections, for example, of the stacked slices.

### BRIEF SUMMARY

In accordance with an embodiment of the present invention, an apparatus for slicing a block of material comprises a harping unit having at least one blade. A feed unit that moves the block of material relative to the at least one blade. The at least one blade slices the block of material and leaves uncut a longitudinal tab of material.

In another aspect a harping unit having a pair of blades is provided. The feeding direction of the feeding unit is substantially parallel to a plane defined by the pair of blades. The pair of blades defines a gap therebetween to slice the block of material in the feeding direction without splitting the block of material into two separate pieces.

In another aspect, a block of cheese is cut into a plurality of slices along its transverse direction. A slit is formed along the longitudinal direction of the block of cheese and a tab of cheese is defined adjacent to the slit to thereby define first and second halves of the block of cheese joined by the tab.

Further aspects and advantages of the invention are described below in conjunction with the present embodiments

### BRIEF DESCRIPTION OF THE DRAWING

The invention, together with the advantages thereof, may be understood by reference to the following description in conjunction with the accompanying figures, which illustrate some embodiments of the invention

FIG. 1 is a schematic perspective view of a cheese log harping apparatus, with harping blades positioned in relation to a feeding tray in accordance with one embodiment of the invention;

FIGS. 2a-2c are illustrating views of harping blades used in accordance with an embodiment of the invention using the harping apparatus of FIG. 1;

FIGS. 3a-3e are schematic perspective views illustrating a longitudinal harping process of the cheese log in accordance with an embodiment of the invention using the harping apparatus illustrated in FIG. 1;

FIG. 4 illustrates schematically a two-conveyor feeding unit in accordance with an embodiment of the invention;

FIGS. 5a-5g illustrate end views and a side view of the cheese log after the longitudinal harping process carried out in accordance with an embodiment of the invention;

FIG. 6 is a perspective view of a stack of cheese slices processed in accordance with an embodiment of the invention and subsequent to a transversal slicing process of the longitudinally sliced cheese log;

FIGS. 7a-7b are perspective views of a cylindrical and a rectangular cheese log, both having cross-shaped slit configurations and transversally sliced in accordance with an embodiment of the invention; and

FIG. 8 is flow chart in accordance with an embodiment of the invention illustrating a slicing process of a cheese log with the slicing apparatus illustrated in FIG. 1.

### DETAILED DESCRIPTION

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “an” object is intended to denote also one of a possible plurality of such objects.

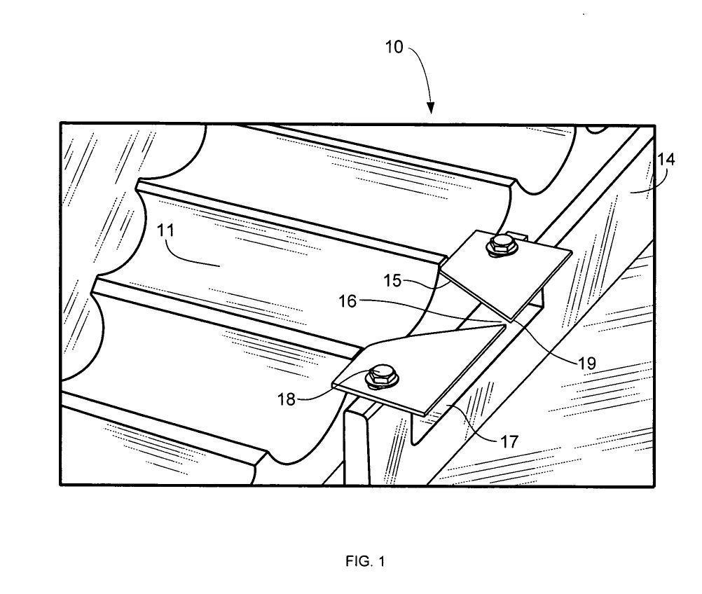

Referring to FIG. 1, a cheese harping apparatus 10 is generally shown. The cheese harping apparatus 10 has a support feed tray 11 upon which food products, such as cheese logs having a cylindrical shape or blocks (not shown) having a rectangular shape may be supported in preparation of a slicing of the cheese logs. As used hereafter the terms log or block refers to a solid chunk of material having a cylindrical, rectangular or other suitable cross-section. It will be recognized that other feeding arrangements such as feed conveyors, belts and the like may be used instead of the feed tray.

Prior to harping, the cheese blocks may be cooled to a suitable slicing temperature. Preferably, the cheese blocks provided for the harping process may exhibit a cooled temperature between about 35 to about 38 degrees Farenheit.

The cheese harping apparatus 10 includes a feeding unit (not shown) adapted to feed the cheese logs on the support feed tray 11 forwardly to a pair of harping blades 13 adaptively attached to a fixed frame 14. In the disclosed embodiment, the pair of blades 13 is configured with opposing angled sides 15, terminating at one distant end from the feed tray 11 into a respective tip 19. The respective and opposite tips 19 of the opposing angled sides 15 define a gap 16 therebetween.

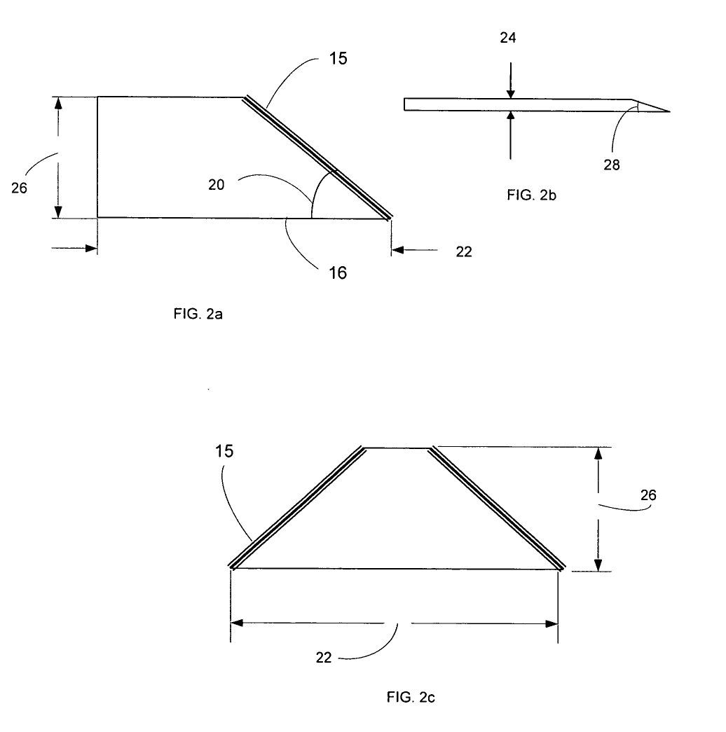

Referring to FIGS. 2a-2c, illustrated therein are embodiments of the harping blades 13. The blades 13 are provided with a substantially triangular or trapezoidal shape, and with substantially flat upper and lower surfaces. The respective angled sides 15 form predetermined angles 20 with adjacent sides 16, and are preferably sharpingly tapered. These predetermined angles 20 are set to between forty and fifty degress, and preferably equal to forty-five degrees. The blades 13 are provided with a predetermined length 22 that facilitates the harping of the cheese log to any desired diametrical depth of the cheese log. For example, the predetermined length 22 of the blades 13 may be between less than half a width of a cross-sectional portion of the cheese log to about twice that width. Preferably, the blades 13 are about 3.5″ to about 3.75″ long. The blades 13 are provided with a thickness 24 that substantialy reduces a harping friction between the blades 13 and the cheese log. For example, the thickness 24 may be about 1/16 of an inch to about 1/10 of an inch, and preferably about 0.120 inch. In addition, the blades 13 have a predetermined width 26 of about 1.75″ to about 2.5″, and preferably about 2″. Additionnally, the blades 13 may be Teflon coated to further reduce the harping friction. As stated above, the angled sides 15 are sharpingly tapered, preferably to a 15 degrees angle 28 on the edge. In order to provide relatively rigid cutting blades 13, a material composition of the blades 13 may be Stainless Steel, for example Stainless Steel No. 316 or hardened Stainless Steel. Alternately, the material composition of the blades 13 may be ceramic or polymeric.

Referring back to FIG. 1, the fixed frame 14 is disposed generally perpendicular to a feeding direction of the cheese blocks. The feeding unit is adapted to move the cheese logs from one side of the feed tray 11 to the other side thereof, adjacent the harping blades 13 via a pneumatic mechanism (not shown), for example. The pneumatic mechanism comprises a pneumatic cylinder connected to a ram, which in turn is connected to a pushing wall of the feeding unit. The pushing wall is provided to come into contact with one longitudinal end of the cheese log during the moving process of the cheese log in relation to the harping blades 13. A feeding rate of the feeding unit can, of course, be adjusted via a controller unit (not shown) to accommodate a suitable harping speed selected from a predetermined range of feeding rates, for example between about one inch per second to about 10 inches per second. A preferred feeding rate is about 2.2 inches per second.

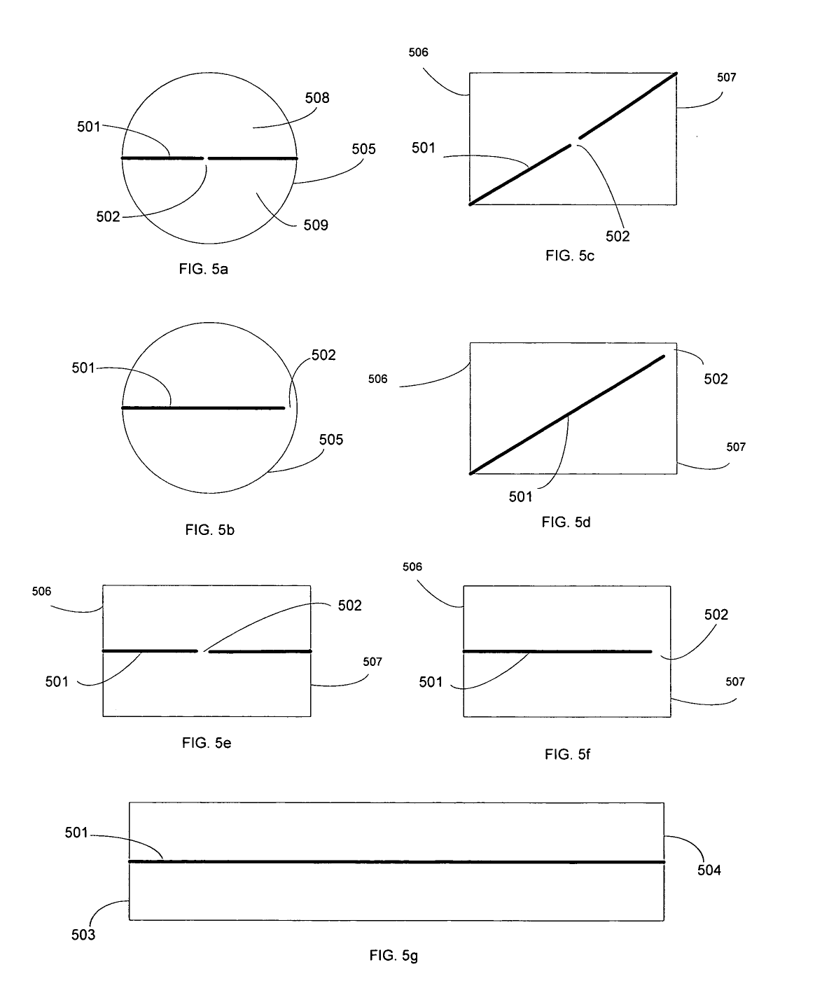

Upon the desired movement of the cheese log on the feeding tray 11, the harping apparatus 10 performs a partial harping (cutting) of a longitudinal length of cheese using the two opposing angle shaped blades 13 with the gap 16 between them. The log (not shown) is cut along a longitudinal axis but the cheese block is not completely severed. As shown in FIGS. 5a-5g, a tab of cheese 502 is defined between or adjacent the slits 501.

Alternatively, the blades 13 can be moved in relation to the cheese log which can remain relatively fixed, or there can be a combination of relative movement between the blades 13 and the cheese block.

With respect to FIG. 1, the cheese harping apparatus 10 can be set up in a plurality of arrangements or blade pairs in which the blades 13 are preferably opposite each other with a gap 16 between the tips of the blades 13. The blades 13 are substantially rigid in comparison to the density of the cheese log to facilitate a straight and smooth harping of the cheese log. In the preferred arrangement, the shape of the blades 13 reduces a friction across each of the blade face during the slicing/harping operation or process. As such, when the cheese is pushed through the substantially rigid blades, a desired partial longitudinal cut of the cheese log is formed.

Preferably, the blades 13 are configured to be adjustably affixed to the frame 14, thereby allowing a width of the gap 16 to be increased or decreased as desired. The width of the gap 16 is preferrably determined so as to minimize undesirable tearing of the cheese slices during a separation of the corresponding half slices. As an example, the width of the gap 16 may be about 1/16 of an inch to about ½ of an inch. The width of the gap 16 is preferably about ⅛ of an inch.

The fixed frame 14 is further provided with an opening or cut-out 17, on either side of which the blades 13 are secured to the fixed frame 14 via bolts, screws 18 or the like. The fixed frame opening 17 may be of any suitable length that can at least accommodate a diameter or a width of the cheese log. As an example, the length of the fixed frame example may be equal to twice the diameter or width of the cheese log. In addition, a vertical height of the fixed frame opening 17 is configured to substantially match a desired location of the harping of the cheese log. As such, the fixed frame 14 may be adjustable in a vertical direction in relation to the feed tray 11. As an example, the vertical height of the fixed frame opening 17 is such that the desired harping location of the cheese log substantially matches a relatively vertical midpoint of the cheese log.

The gap 16 defined between the blades 13 creates or leaves uncut a small connection of cheese or tab between the partially split longitudinal halves of the cheese log. That is, the slits and tab formed by the harping apparatus 10 enables the log of cheese to stay substantially intact in its original shape for further handling without coming apart into two separate longitudinal halves. The result is improved slicing of the cheese block at a later stage in a cheese slicing process. The small tab connecting the first and second longitudinal halves of the cheese block enables operations on the cheese block without negatively impacting subsequent handling of the cheese block. For example, the tab helps to improve the speed of a cross-sectionnal slicing apparatus, and an improved stacking and packing of the finished slices. As the blades 13 are adjustably affixed to the frame 14, the small connection or tab of cheese created longitudinally within the cheese log may be positioned at any predetermined height of the cheese log.

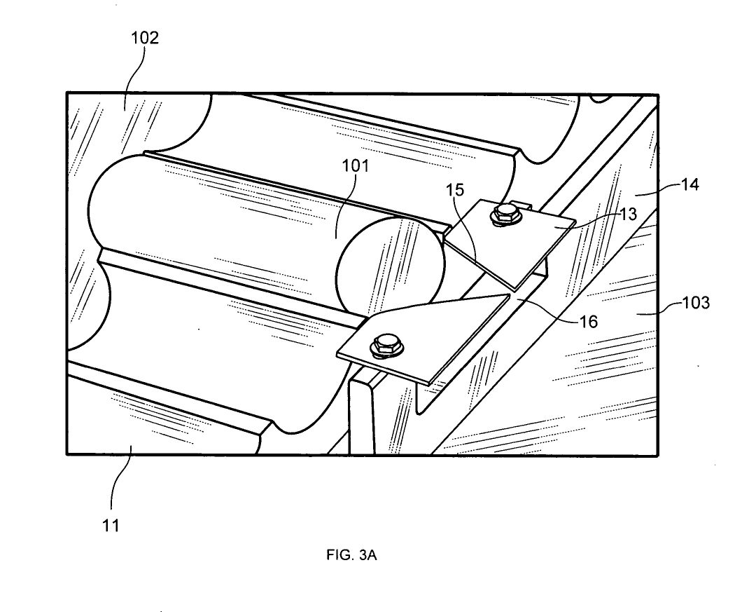

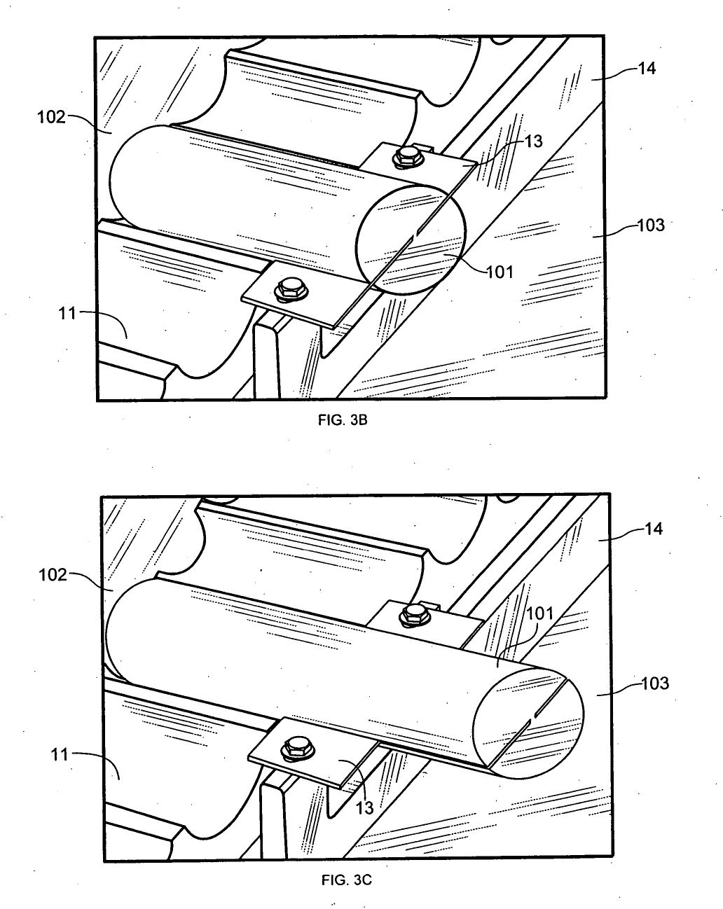

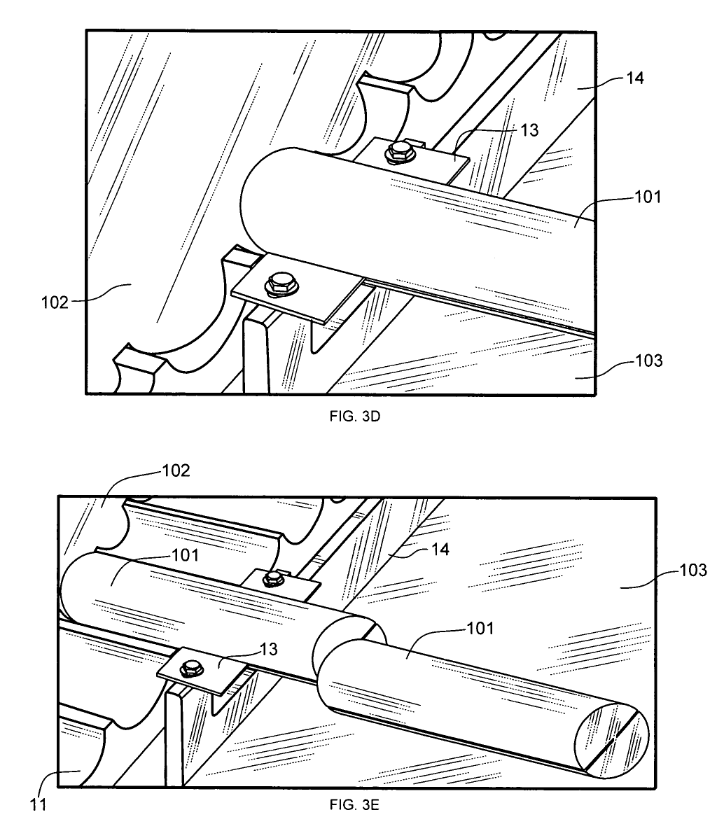

Now referring to FIGS. 3a-3c, the cheese log 101 is initially disposed in a corresponding feed tray 11 upstream in relation to the feeding direction from the harping blades 13. In order to maintain the cheese log 101 in a substantially straight feeding direction, in the disclosed embodiment, the feed tray 11 is provided with a cheese log contact surface that partially matches an outer contour of the cheese log 101. The cheese tray may be of any material that facilitates a sliding of the cheese log on the cheese log contact surface, for example Stainless Steel. The cheese log contact surface may be concave to match the contour of a cylindrical cheese log. The feeding unit or cheese log mover 102 includes a bottom surface configured to at least partially conform to a transversal contour of the feed tray 11. As such, during the harping process, the cheese log 101 is confined into a fixed transversal position on the feed tray 11, while being pushed by the feed unit 102 along a feeding direction toward the opposing blades 13. As an example, the vertical depth of the concave surface of the feeding tray may be equal to or less than the radius or half the height of the cheese log. In the case of a cylindrical cheese log, the vertical depth of the feeding tray is between about ¼ to about ½ the radius of the cheese log.

Alternately, the contact surface of the feeding tray 11 may include intermittent conveyor rollers as the cheese contact surface. Typically these rollers are set to idle, but may also be driven to support the feeding unit in the pushing motion of the cheese log 101 towards the cutting blades 13. The feeding unit 102 may be driven or be biased against the fixed frame 14.

Referring to FIG. 3d, as introduced above, the suitable feeding rate of the feeding unit 102 is sufficient to push or propel completely the cheese log 101 through the cutting blades 13. Alternately, the feeding unit 102 may also be configured with forward extensions (not shown) that can be pushed part-way through the blades gap 16 to push the entire length of the cheese log 101 through the cutting blades 13. Prior to activating the feeding unit 102, to move one or more cheese logs 101, the feeding unit 102 is disposed at or adjacent to one end of the feed tray 11 that is remote from the cutting blades 13. When activated, the feeding unit 102 may push one or more cheese logs 101 longitudinally along the length of the corresponding feed tray 11. As the feeding unit 102 pushes the cheese logs 101, the harping blades 13 come into contact with and partially slice the cheese log 101 along its longitudinal length.

Now referring to FIG. 3e, once completely sliced along its longitudinal length, the cheese log 101 is pushed onto a table top or conveyor 103 for further processing. Having reached the extent of its travel in proximity of the blades 13, the feeding unit 102 is configured to retract back to a starting position at the one end of the feeding tray 11 remote from the harping blades 13, so that additional cheese logs are disposed in the corresponding feed tray 11. The cheese logs may be provided on the feed tray 11 manually or may be appropriately discharged on the feed tray 11 by a suitable mechanism, such as a conveyor or belt.

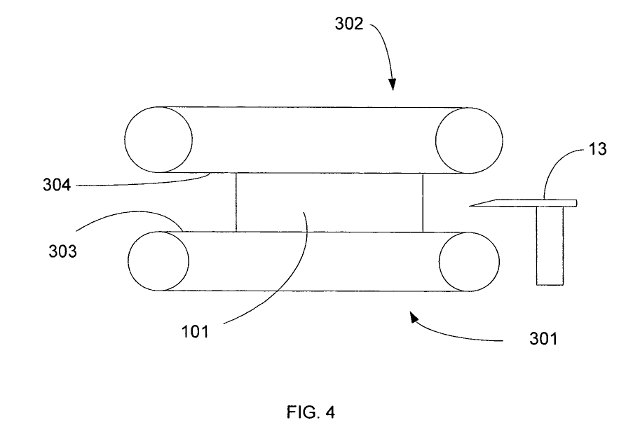

In an aspect, as illustrated in FIG. 4, the cheese log 101 may be positioned between two conveyors 301 and 302 in order to advance the cheese log 101 through the harping blades 13. The first supporting conveyor 301 is configured to receive the cheese log 101 on a support belt or roller 303. The second conveyor 302 is configured to overlay the cheese log 101 with a hold-down or push-down belt or roller 304. In this arrangement, the cheese log 101 is sandwiched between the first and second conveyors 301 and 302 during the harping process. To minimize lateral or transversal sliding of the cheese log 101 in relation to the two conveyors 301 and 302 during the harping process, the first conveyor 301 is biased against the second conveyor 302 through the cheese log 101. Further, to facilitate the advancement of the cheese log 101 through the harping blades 13, the support belt or conveyor 303 and the hold-down belt or conveyor 304 may each comprise respective contact surfaces with suitable friction characteristics. At least one of the two conveyors 301 and 303 is driven to suitably provide the predetermined feeding rate of the cheese log 10, and preferably both conveyors 301 and 302 are driven.

Referring to FIGS. 5a, 5b and 5g, end views and a side view of the sliced cheese block 101 are shown. Once sliced, the cheese log 101 has at least one longitudinal slit 501 formed from a first longitudinal end 503 of the cheese log to a second longitudinal end 504. As shown in FIG. 4a, the two longitudinal slits 501 are separated by the longitudinal cheese connection or tab 502 which corresponds in width to the relatively small width of the gap 16 defined between the opposing tips 19 of the harping blades 13. The longitudinal tab 502 may be created via a single blade at a radial end of the cheese log 101, i.e. near longitudinal outer surface 505 of cheese log 101, as shown in FIG. 5b.

Hence, the connecting tab 502 enables the cheese log 101 to stay substantially intact in its original shape for further handling without coming apart into two separate longitudinal halves. The width of the tab 502 can be varied according to the adjustable width of the gap 16. The width of the tab 502 can thus be adjusted to any desirable value, but is preferably approximately ⅛ of an inch. The width of the tab 502 may vary in relation to a density, water content, or a type of the cheese block or other item (such as meat) being considered for harping. Alternatively, it will be recognized that the tab may be formed in any suitable position along the length of the cheese block by changing the position of the blades 13.

In another aspect, the harping apparatus 10 is also configured to longitudinally slice a rectangular cheese log 101. As shown in FIGS. 5c-5f, the rectangular cheese log 101 provided for harping comprises a substantially rectangular cross-section. For this rectangular cheese log 101, the blades 13 may be configured in relation to the feed tray 11 to slice the cheese log 101 along any two opposing longitudinal sides 506 and 507. Alternatively, the blades 13 may be positioned at suitable angles in relation to the feed tray 11 to slice the rectangular cheese log 101 along an imaginary line connecting two opposing corners of the cheese log 101. As such, and referring to FIGS. 5e and 5f, the formed cheese slices have a substantially triangular shape, as the formed slit 501 and connecting tab 502 are situated along a corresponding hypotenuse connecting the sliced opposing corners.

Referring back to FIG. 3e, once the sliced cheese log 101 has been pushed away from the blades 13 and onto the conveyor 103, the cheese log 101 is subsequently sliced cross-sectionally or transversal to the longitudinal axis to create multiple slices of cheese. In a preferred embodiment, the cross-sectional slicing is accomplished using a second harping mechanism (not shown). The second harping mechanism may be, for example, a commercially available German slicing machine manufactured by Schindler & Wagner GmbH & Co., a.k.a. SHIWA, under Model #10380. This SHIWA machine is provided to make only transversal cuts. In order to ensure the transversal cutting of the cheese log 101 by the SHIWA machine, the longitudinally sliced cheese log 101 is aligned with the SHIWA machine with guide plates, for example. Such guides (not shown) may comprise thin sheets of material, such stainless steel, are aligned along a length of the conveyor 103 to receive and guide the sliced cheese log 101 toward the SHIWA machine. The SHIWA machine utilizes rotary blades to cut the sliced cheese log 101 into individual cross-sectional slices. Alternatively, a second feeding unit or pusher (not shown) pushes or hands-off the sliced cheese log 101 to the SHIWA machine to cut the cheese log 101 into a series of parallel slices of cheese. The SHIWA machine is provided with a programmable unit to adjustably slice the cheese log 101 according to any desirable weight or thickness of the cheese slices. The thickness of the cheese slices may be between about 0.080″ to about 0.105″, and preferably about 0.090″.

After the cross-sectional cheese slices are produced or cut from the sliced cheese block 101, the SHIWA machine is also configured to introduce or place a suitable separator between the cheese slices. The suitable slice separator may be waxed parchment, or the like. The SHIWA machine is further configured to stack the separated individual cheese slices, prior to handing off the cheese stacks to a wrapping machine.

Alternately, the individual cheese slices can be stacked without separators, for example when a low moisture content of the cheese slices minimizes a potential sticking of adjacent cheese slices.

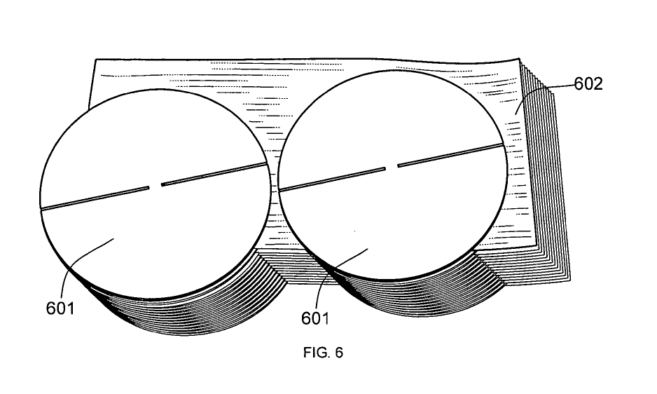

Referring to FIG. 5a, once a slice is made, the slice can be divided again into two separate sections 508 and 509 easily by breaking the connecting tab 502 small connecting piece of cheese between the two sections of the slice. A couple of stacks 601 of cheese slices are shown in FIG. 6, with the slice separator 602, such as waxed paper, sandwiched between adjacent slices of each stack to prevent them from sticking to one another.

Alternatively, the harping apparatus may include a plurality of pairs of blades 13 with a corresponding plurality of feed trays 11. As such, a plurality of blocks of cheese 101 can be pushed through the plurality of blades 13 simultaneously by a single push of the feed unit 102, whereupon the feed unit 102 is retracted to allow additional blocks of cheese 101 to be placed on the plurality of feed trays 11. Further, another plurality of cheese logs 101 may be placed in series on a single feed tray 11 to slice them serially by a single push of the feed unit 102, whereupon the feed unit 102 is retracted to make room for placing additional blocks of cheese 101 between the feed unit 102 and the harping blades 13.

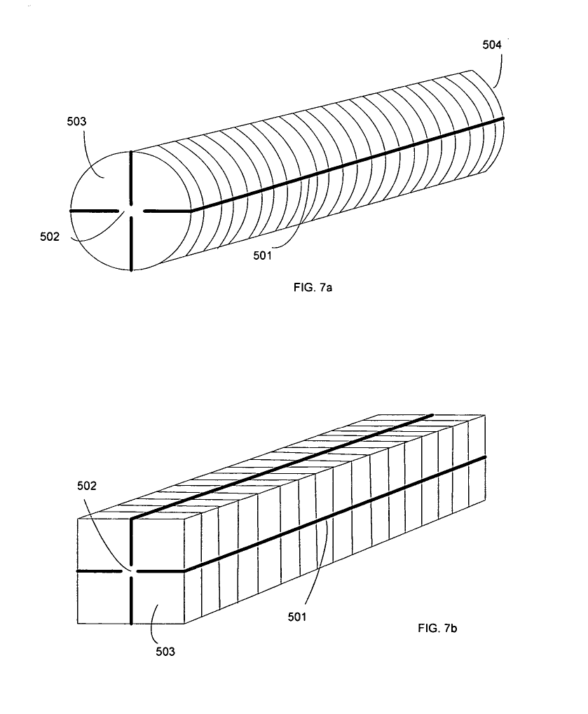

Another aspect is to provide a harping apparatus with two pairs of harping blades. The two pairs of harping blades 13 may be positioned such that one plane formed by a first pair of blades 13 is substantially perpendicular to another plane formed by the second pair of blades 13. As shown in FIGS. 7a and 7b, once sliced the cheese log 101 has four longitudinal slits 501 formed from a first longitudinal end 503 to a second longitudinal end 504. The four longitudinal slits 501 are separated at a substantially cross-sectional center of the cheese log 101 by the longitudinal connecting tab 502, and the slits 501 form a generally cross-shaped configuration. As discussed above, the longitudinal tab 502 enables a handling of the cheese log without negatively impacting subsequent handling of the cheese log. For example, the tab 502 enables the cheese log 101 to stay substantially intact in its original shape for further handling without coming apart into four separate longitudinal halves.

Still another aspect is to provide a harping apparatus 10 with at least two pairs of blades 13 configured to progressively slice the cheese log 101 at two different respective depths along the correspondingly formed longitudinal slits. These two pairs of blades 13 are positioned downstream from one another along the feeding direction. As such, when the cheese log 101 is pushed by the feed unit 102 relative to the two sets of blades 13, the first pair of blades 13 is configured to slice the cheese log to a first radial or cross-sectional depth, thereby creating two longitudinal slits 501. Then, as the cheese log 101 reaches and is pushed through the second pair of blades 13, the second pair of blades 13 is configured to further slice the cheese log 101 by deepening the created longitudinal slits 501 to a second cross sectional depth. One would recognize that additional pair of blades 13 may be suitably used with increasingly deeper slicing capabilities to form the connecting tab 502 with a desirable thickness.

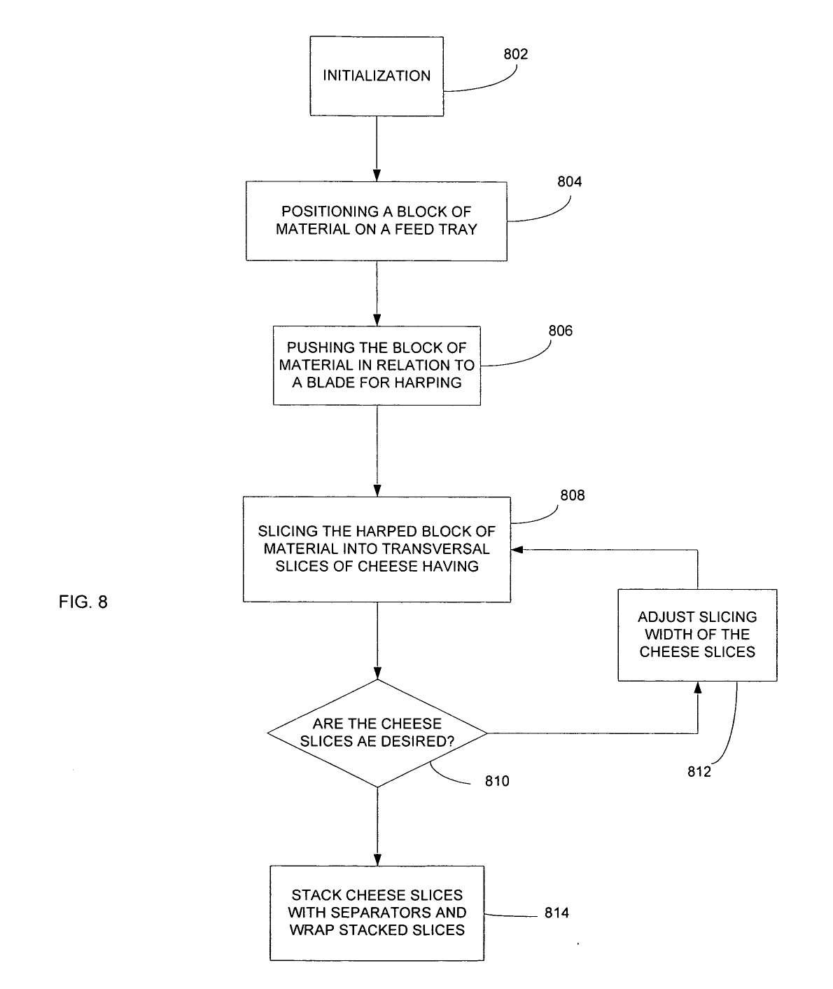

Now referring to FIG. 8, an embodiment of a method of slicing a log of cheese is shown. The method of slicing a log of cheese is initialized at step 802. A log of cheese is disposed on a feed tray between a feed unit and a harping unit, at step 804. The log of cheese is pushed by the feeding unit towards and through at least one blade and preferably a pair of harping blades of the harping unit, at step 806. The longitudinally harped log of cheese is further cut transversally into slices, at step 808, via a transversal slicing mechanism. At step 810, a controller unit of the transversal mechanism communicates corrective instructions to the slicing mechanism to produce a predetermined weight or thickness of the cut slices. At step 812, the produced cheese slices are stacked with a separator introduced between adjacent cheese slices. Thereafter, the method ends by wrapping the stacked cheese slices at step 814.

Once sliced by the harping apparatus 10, the cheese log 101 comprises at least one slit formed trough a length of the cheese log in the longitudinal direction, and a tab of cheese formed adjacent the at least one slit to define a first longitudinal half log of cheese and a second longitudinal half log of cheese. The first and second halves logs of cheese are joined along the longitudinal direction by the tab of cheese. The first and second halves logs of cheese are then divided into a plurality of cheese slices along a transversal direction. Thus, each of the plurality of cheese slices comprises two half portions joined by a corresponding transversal section of the longitudinal tab.

While a preferred embodiment of the invention has been described, it should be understood that the invention is not so limited, and modifications may be made without departing from the invention. For example, the harping blades may have undulating cutting sides which reduce a contact surface of two adjacent slices, to minimize a sticking of the two adjacent cheese slices. The scope of the invention is defined by the appended claims, and all devices that come within the meaning of the claims, either literally or by equivalence, are intended to be embraced therein.

We claim:

1. An apparatus for slicing a block of material, the apparatus comprising:
a harping unit having at least one blade; and
a feed unit that moves the block of material relative to the at least one blade,
wherein the at least one blade is arranged to longitudinally slice the block of material and leave uncut a longitudinal tab of material.

2. The apparatus of claim 1, wherein the block of material is a substantially cylindrical block of cheese.

3. The apparatus of claim 1, wherein the block of material is a substantially rectangular block of cheese.

4. The apparatus of claim 1, wherein the feed unit comprises a feed tray that holds the block of material and a mechanism that pushes the block of material on the feed tray.

5. The apparatus of claim 1, wherein the feed unit comprises two conveyors, biased against one another through the block of material, to advance the block of material in relation to the at least one blade.

6. The apparatus of claim 1, wherein the at least one blade has an angle side tapered for harping the block of material.

7. The apparatus of claim 1, wherein the at least one blade is substantially rigid.

8. The apparatus of claim 1, wherein the at least one blade is positionally adjustable to change a width of the tab.

9. The apparatus of claim 1, wherein the tab has a width of about ⅛ of an inch.

10. The apparatus of claim 1, wherein the feed unit is driven by a mechanical apparatus.

11. The apparatus of claim 10, wherein the mechanical apparatus is a pneumatic mechanism.

12. The apparatus of claim 11, wherein the pneumatic mechanism comprises a controller unit configured to adjust a feeding rate of the feed unit.

13. The apparatus of claim 1, further comprising a slicing unit to transversally slice the longitudinally sliced block of material to produce slices that have the connecting tab of material.

14. The apparatus of claim 13, further comprising a stacking unit to stack the produced slices.

15. The apparatus of claim 14, wherein the stacking unit introduces a separator between adjacent slices to minimize a sticking of the adjacent slices.

16. The apparatus of claim 14, wherein the slice separator comprises waxed parchment.

17. The apparatus of claim 14, further comprising a wrapping unit to wrap the stacks of produced slices.

18. An apparatus for producing cheese slices from a block of material having a longitudinal direction and a lateral direction, the apparatus comprising:
a harping unit having at least one blade;
a feed unit that moves the block of material in a direction of the longitudinal direction of the block of material relative to the at least one blade, the at least one blade slices the block of material and leaves uncut a longitudinal tab of material; and
a slicing unit to transversally slice the longitudinally sliced block of material to produce slices that have the connecting longitudinal tab of material.

19. An apparatus for producing cheese slices from a block of material having a longitudinal direction and a lateral direction, the apparatus comprising:
a harping unit having a pair of blades;
a feed unit that moves the block of material in a direction of the longitudinal direction of the block of material relative to the pair of blades, the pair of blade slices the block of material and leaves uncut a longitudinal tab of material; and
a slicing unit to transversally slice the longitudinally sliced block of material to produce slices that have the connecting tab of material.

20. The apparatus of claim 19, wherein the pair of blades is configured with opposing angled sides, and each one of the pair of blades having respective and opposite cutting tip.

21. The apparatus of claim 19, wherein the opposite cutting tips define a gap that corresponds to a width of the longitudinal tab.

22. An apparatus for producing cheese slices from a plurality of blocks of material, each of the plurality of blocks of material having a longitudinal direction and a lateral direction the apparatus comprising:
a plurality of harping units having each at least one corresponding blade;
at least one feed unit that moves the plurality of blocks of material in a direction of the longitudinal direction of the blocks of material relative to the plurality of harping units, such that each of the at least one corresponding blades slices the corresponding blocks of material and leaves uncut a longitudinal tab of material on each of the corresponding blocks of material; and
at least one slicing unit to transversally slice the plurality of longitudinally sliced blocks of material to produce slices that have the connecting tab of material.

23. The apparatus of claim 22, wherein the pair of blades is adaptively attached to a fixed frame.

24. The apparatus of claim 22, wherein the pair of blades is configured with opposing angled sides, the opposing angled sides being tapered and having each a respective cutting tip.

25. An apparatus for slicing a block of material, the apparatus comprising:
a harping unit having a plurality of blades; and
a feed unit that moves the block of material relative to the plurality of blades,
wherein the plurality of blades are positioned sequentially downstream from one another in a feeding direction to progressively slice the block of material at a plurality of respectively different depths, thereby forming a longitudinal slit and leaving uncut a longitudinal tab of material.

26. A method of slicing a block of material via a cutting harp, the method comprising:
positioning the block of material on a feed tray upstream of a harping unit, the harping unit having a pair of blades defining a gap therebetween; and
driving a feed unit relative to the pair of blades, thereby harping the block of material and leaving uncut a tab of material.

27. The method of claim 26, further comprising controlling a slicing unit to transversally slice the longitudinally sliced block of material to produce cheese slices that have a corresponding section of the connecting tab of material.

28. A cheese product comprising:
a block of cheese having a longitudinal direction and a lateral direction, the block of cheese formed into a plurality of slices along the lateral direction;
at least one slit formed through a length of the block of cheese in the longitudinal direction; and
a tab of cheese formed adjacent the at least one slit to thereby define a first longitudinal half block of cheese comprised of slices of cheese and a second longitudinal half block of cheese formed of the slices of cheese, the first and second longitudinal half blocks of cheese joined along the longitudinal direction by the tab of cheese.

29. The cheese product of claim 28, further comprising four longitudinal slits formed through the length of the block of cheese, the four longitudinal slits thereby defining four transversal sections connected by the tab of cheese.

30. The cheese product of claim 28 wherein the block of cheese comprises a cylindrical shaped block.

31. The cheese product of claim 28 wherein the block of cheese comprises a rectangular shaped block.

32. The cheese product of claim 28, further comprising two slits extending from the tab to a transversal end of the block of cheese.

33. The cheese product of claim 29, wherein the four longitudinal slits form a cross shaped slit configuration.

34. The cheese product of claim 32, wherein the block of cheese comprises a cylindrical shaped block.

35. The cheese product of claim 32, wherein the block of cheese comprises a rectangular shaped block.

36. The cheese product of claim 28, wherein the block of cheese is transversally sliced.
